(19) United States
(12) Patent Application Publication
(10) Pub. No.: US 2025/0132972 A1
(43) Pub. Date: Apr. 24, 2025

(54) BGP NEXT-HOP GROUPS FOR MULTI-HOMED SERVICES IN SCALED SERVICE PROVIDER NETWORKS

(71) Applicant: Cisco Technology, Inc., San Jose, CA (US)

(72) Inventors: Tarek Saad, Nepean (CA); Neeraj Malhotra, Milpitas, CA (US); Satya R Mohanty, San Ramon, CA (US); Nitin Kumar, San Jose, CA (US)

(21) Appl. No.: 18/489,057

(22) Filed: Oct. 18, 2023

(51) Int. Cl. H04L 41/0659; H04L 45/02

(52) U.S. Cl. CPC H04L 41/0659; H04L 45/04

(57) ABSTRACT

Methods and systems are described herein for reducing border gateway protocol (BGP) signaling for multi-homed devices. In one aspect, the method comprises: receiving one or more signals from one or more provider edge devices. The one or more signals include an address of a membership group associated with a multi-homed device. A router receives, from a provider edge device of the one or more provider edge devices, a service prefix. The service prefix is associated with the multi-homed device and the membership group. The router may store the service prefix and the one or more provider edge devices and connect, according to the service prefix and the one or more provider edge devices, to the multi-homed device associated with the membership group.

### TECHNICAL FIELD

The present technology pertains to Border Gateway Protocol Next-Hop Group (BGP-NHG) and, more specifically, to reducing signaling in a BGP-NHG configuration upon a connectivity failure on a network.

### BACKGROUND

Customer services require high reliability on a service provider network. Customer edge (CE) multi-homing is usually deployed to improve network reliability and optimize network resources. A multi-homed CE may connect to the same or different provider edge (PE) devices over multiple links that belong to the same VPN. In such cases, the redundant links can work in load-balancing mode or active/standby mode to provide the desired reliability against network failures. Border gateway protocol (BGP) is the de-facto protocol used for providing connectivity and redundancy for services across a service provider network. When customer services are multi-homed to multiple PE devices, each of the PE devices will originate reachability for service prefixes and advertise it to remote PE devices. Remote PE devices, depending on the path redundancy mode (load-balancing or active), may select a single best PE device for enabling load-balancing traffic onto redundant PE devices that are connected to the customer services.

In case of failure of a single CE-PE device link of a multi-homed CE hosting a scaled number of services, the PE device will have to withdraw reachability to all affected services that are reachable via the failed CE-PE device link. This allows remote PE devices to compute a new best PE device, or update load-balancing for reaching the customer services. In a scaled deployment, a large number of VPNs and service prefixes may be affected by a single CE-PE link failure or recovery. In this case, the amount of BGP signaling/messaging post-failure or post-restoration of the failed CE-PE link increases drastically with the number of VPN and service prefixes, leading to a heavy load on the control plane and slowing down the network convergence.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example communication network including one or more autonomous systems (ASes) in accordance with aspects of the present disclosure.

FIG. 2A illustrates an example block diagram of a border gateway protocol next-hop group (BGP-NHG) in accordance with aspects of the present disclosure.

FIG. 2B illustrates an example block diagram of a BGP-NHG with a failed customer-to-provider (CE-PE) connectivity failure in accordance with aspects of the present disclosure.

FIG. 3 illustrates an example flowchart for updating a routing information base (RIB) table following a CE-PE connectivity failure in accordance with aspects of the present disclosure.

FIG. 4 illustrates an example flowchart for advertising service routes and signaling reachability in a BGP-NHG in accordance with aspects of the present disclosure.

FIG. 5 shows an example of a system for implementing certain aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

Methods and systems are described herein for reducing border gateway protocol (BGP) signaling for multi-homed devices. In one aspect, the method includes receiving one or more signals from one or more provider edge devices. The one or more signals include an address of a membership group associated with a multi-homed device. A remote device receives, from a provider edge device of the one or more provider edge devices, a service prefix. The service prefix is associated with the multi-homed device and the membership group. The remote device may store the service prefix and the one or more provider edge devices and connect, according to the service prefix and the one or more provider edge devices, to the multi-homed device associated with the membership group.

In some aspects, the remote device may update the stored service prefix and the stored one or more provider edge devices after a deviation of the one or more signals. In some aspects, the provider edge device is an elected provider edge device selected by the one or more provider edge devices of the membership group.

In some aspects, the deviation is caused by a change of a signal of the one or more signals, indicating a withdrawal of a failed provider edge device from the membership group. In some aspects, the service prefix and the one or more provider edge devices are stored in a data table associated with the membership group. In some aspects, the service prefix is further associated with one or more VPN service route(s).

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

A computer network is a geographically distributed collection of nodes interconnected by communication links and segments for transporting data between end nodes, such as personal computers and workstations, or other network devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other.

Since management of interconnected computer networks can prove burdensome, smaller groups of computer networks may be maintained as routing domains or autonomous systems. An Autonomous System (AS) is a network or group of networks under common administration and with common routing policies. A typical example of an AS is a network administered and maintained by an Internet Service Provider (ISP). Customer networks, such as universities or corporations, connect to the ISP, and the ISP routes the network traffic originating from the customer networks to network destinations that may be in the same ISP or may be reachable only through other ISPs.

To facilitate the routing of network traffic through one or more ASes, the network elements of the ASes need to exchange routing information to various network destinations. Border Gateway Protocol (BGP) is an Exterior Gateway Protocol (EGP) that is used to exchange routing information among network elements (e.g., routers) in the same or different ASes. A computer host that executes a BGP process is typically referred to as a BGP host or a BGP network device. To exchange BGP routing information, two BGP hosts, or peers, first establish a transport protocol connection with one another. Initially, the BGP peers exchange messages to open a BGP session, and, after the BGP session is open, the BGP peers exchange their entire routing information. Thereafter, only updates or changes to the routing information are exchanged, or advertised, between the BGP peers. The exchanged routing information is maintained by the BGP peers during the existence of the BGP session.

The networks within an AS are typically coupled together by conventional “intradomain” routers configured to execute intradomain routing protocols, and are generally subject to a common authority. To improve routing scalability, a service provider (e.g., an ISP) may divide an AS into multiple “areas” or “levels.” It may be desirable, however, to increase the number of nodes capable of exchanging data; in this case, interdomain routers executing interdomain routing protocols are used to interconnect nodes of the various ASes. Moreover, it may be desirable to interconnect various ASes that operate under different administrative domains. As used herein, an AS, area, or level is generally referred to as a “domain.”

The disclosed technology addresses the need in the art for a method of reducing border gateway protocol (BGP) signaling for multi-homed devices. One or more PE devices can be connected to a single multi-homed CE device and form a membership group referred to as a BGP-NHG. PE devices that are members of the BGP-NHG each originate a BGP-NHG route that announces to remote PE devices that it is part of the BGP-NHG and ready to receive and forward traffic to the CE device. A remote PE device forms an equal-cost multi-path (ECMP) next-hop set that is derived from the BGP-NHG routes received from PE devices that are members of the BGP-NHG. The remote PE device uses subsequent BGP-NHG route add/withdraw that is learned from a specific BGP-NHG member PE device to update the ECMP Pathlist associated with the BGP-NHG.

A service route that is advertised by the multi-homed CE and learned by a member PE device of the BGP-NHG can be advertised with an additional BGP-NHG prefix attached. The prefix allows remote PE devices to immediately program the service route as reachable via all equal-cost multi-path (ECMP) next-hops, even if a remote PE device does not receive a service route from all the redundant PE device members of the BGP-NHG. In this case, a single BGP-NHG route addition can impact all the service routes that resolve over the prefix attached. In case of a failure of a CE-PE device link, the affected PE signals a BGP-NHG “route withdraw” to remote PE devices. The BGP-NHG “route withdraw” impacts all the service routes that resolve over the prefix attached. In this case, the remote PE devices can update the BGP-NHG membership and the ECMP next-hops (e.g., remove the affected PE device from the ECMP next-hop set of the BGP-NHG) for all service routes that resolve over the BGP-NHG. Additionally, a designated speaker PE device of the BGP-NHG group does not send any individual VPN service route updates in the case of a route withdraw or a route addition. All VPN service route(s) that resolve over the BGP-NHG are updated immediately without the need to receive a per-service-route withdraw from the failed PE device. This reduces the amount of signaling required post-failure to one per BGP-NHG route update, therefore resulting in faster control plan convergence after a CE-PE device link failure or restoration.

Additionally, only a single PE device of a set of member PE devices connected to a multi-homed CE device signals reachability to the services routes on behalf of all redundant PE devices that are a member of a BGP-NHG. Traditionally, each PE device connected to the multi-homed CE will advertise reachability to every service route learned from the multi-homed CE. This creates redundant BGP signaling and processing overhead as well as a need to store and process redundant BGP paths on receiving BGP peers. The designated speaker in this second proposed embodiment is selected for each BGP-NHG that becomes responsible for advertising prefix updates for the BGP-NHG. A remote PE device that processes a service route with the prefix can resolve the service route over all ECMP next-hop PE devices that are members of the BGP-NHG. Limiting the reachability signaling to one PE device and reducing the required signaling for a route withdraw event allows for faster convergence of a control plan upon CE-PE device link failure and restoration.

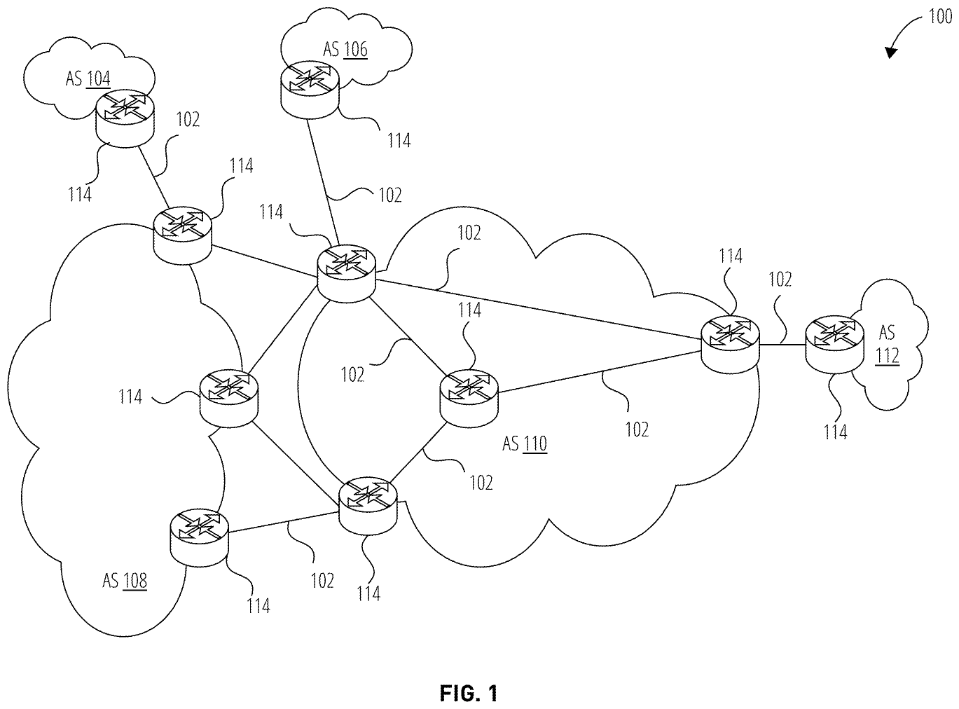

FIG. 1 is a schematic block diagram of an example computer network 100 illustratively comprising network devices 114 interconnected by various methods of communication. For instance, the links 102 may be any suitable combination of wired links and shared media (e.g., wireless links, Internet Exchange Points, etc.) where certain network devices 114, such as, e.g., routers, computers, etc., may be in communication with other network devices 114, e.g., based on distance, signal strength, current operational status, location, etc. Those skilled in the art will understand that any number of network devices 114, links, etc. may be used in the computer network, and that the view shown herein is for simplicity.

Data packets (e.g., traffic and/or messages sent between the network devices 114) may be exchanged among the network devices 114 of the computer network 100 using predefined network communication protocols such as certain known wired protocols, as well as wireless protocols or other shared-media protocols where appropriate.

The computer network 100 includes a set of autonomous systems (AS) 104, 106, 108, 110 and 112. The computer network 100 may be positioned in any suitable network environment or communications architecture that operates to manage or otherwise direct information using any appropriate routing protocol or data management standard. For example, computer network 100 may be provided in conjunction with a border gateway protocol (BGP).

As noted above, an AS may be a collection of connected Internet Protocol (IP) routing network devices 114 under the control of one or more network operators that presents a common, clearly defined routing policy to a network (e.g., the Internet). Usually, an AS comprises network devices 114 that are established on the edge of the system, and that serve as the system's ingress and egress points for network traffic. Moreover, the network devices 114 may be considered edge network devices, border routers, or core network devices within the respective AS. These network devices typically, but not always, are routers or any other element of network infrastructure suitable for switching or forwarding data packets according to a routing protocol or switching protocol. For the purposes of the present disclosure, the network devices 114 located within an AS may alternatively be referred to as “forwarding network devices” or “intermediate network devices.” Moreover, for illustration purposes, the ASes 104, 106, 108, 110, and 112 are shown with a limited number of network devices 114. In an actual implementation, however, an AS normally comprises numerous routers, switches, and other elements.

Each AS 104, 106, 108, 110, and 112 may be associated with an Internet Service provider (ISP). Even though there may be multiple ASes supported by a single ISP, the Internet only sees the routing policy of the ISP. That ISP must have an officially registered Autonomous System Number (ASN). As such, a unique ASN is allocated to each AS for use in BGP routing. ASNs are important primarily because they uniquely identify each network on the Internet.

To facilitate the routing of network traffic through the ASes, or more specifically, the network devices 114 within the ASes, the network devices may exchange routing information to various network destinations. As described above, BGP is conventionally used to exchange routing and reachability information among network devices 114 within a single AS or between different ASes. One particular example of BGP is BGPv4, as defined in Request for Comments (RFC) 1771 of the Internet Engineering Task Force (IETF). Various embodiments may implement other versions of BGP, however, and the use of BGPv4 is not required. The BGP logic of a router is used by the data collectors to collect BGP AS path information, e.g., the “AS_PATH” attribute, as described further below, from BGP tables of border routers of an AS, to construct paths to prefixes.

To exchange BGP routing information, two BGP hosts (network devices 114), or peers, first establish a transport protocol connection with one another. Initially, the BGP peers exchange messages to open a BGP session, and, after the BGP session is open, the BGP peers exchange their entire routing information. Thereafter, in certain embodiments, only updates or changes to the routing information, e.g., the “BGP UPDATE” attribute, are exchanged, or advertised, between the BGP peers. The exchanged routing information is maintained by the BGP peers during the existence of the BGP session.

The BGP routing information may include the complete route to each network destination, e.g., “destination network device,” that is reachable from a BGP host. A route, or path, comprises an address destination, which is usually represented by an address prefix (also referred to as prefix), and information that describe the path to the address destination. The address prefix may be expressed as a combination of a network address and a mask that indicates how many bits of the address are used to identify the network portion of the address. In Internet Protocol version 4 (IPv4) addressing, for example, the address prefix can be expressed as “9.2.0.2/16”. The “/16” indicates that the first 16 bits are used to identify the unique network leaving the remaining bits in the address to identify the specific hosts within this network.

A path joining a plurality of ASes, e.g., links 102, may be referred to as an “AS_PATH.” The AS_PATH attribute indicates the list of ASes that must be traversed to reach the address destination. For example, as illustrated in FIG. 1, the AS 112 may store an AS PATH attribute of “104 106 110 112” where the address destination is the AS 112 (or a particular IP address within AS 112). Here, the AS_PATH attribute indicates that the path to the address destination AS 112 from AS 108 passes through ASes 104, 106 and 110, in that order.

Although it may be preferable that all network devices 114 in the respective ASes 104, 106, 108, 110, and 112 be configured according to BGP, in a real-world implementation, it may be unlikely that each network device communicates using BGP. Thus, the disclosed embodiments are applicable to scenarios where all network devices 114 in the computer network 100 are configured according to BGP, as well as scenarios where only a subset of the network devices 114 is configured as such. Moreover, between any of the ASes, there may be a single communication path 102, e.g., between AS 104 and AS 108, as shown in FIG. 1, or there may be multiple communication paths 102, e.g., between AS 108 and AS 110. Thus, the disclosed embodiments are applicable to either case, as described in further detail below.

Moreover, a security extension to the BGP has been developed, referred to as BGPSEC, which provides improved security for BGP routing. BGP does not include mechanisms that allow an AS to verify the legitimacy and authenticity of BGP route advertisements. The Resource Public Key Infrastructure (RPKI) provides a first step towards addressing the validation of BGP routing data. BGPSEC extends the RPKI by adding an additional type of certificate, referred to as a BGPSEC router certificate, that binds an AS number to a public signature verification key, the corresponding private key of which is held by one or more BGP speakers within this AS. Private keys corresponding to public keys in such certificates can then be used within BGPSEC to enable BGP speakers to sign on behalf of their AS. The certificates thus allow a relying party to verify that a BGPSEC signature was produced by a BGP speaker belonging to a given AS. Thus, a goal of BGPSEC is to use signatures to protect the AS Path attribute of BGP update messages so that a BGP speaker can assess the validity of the AS Path in update messages that it receives. It should be understood, however, that the embodiments for implementing AS Path security disclosed herein are not limited to BGPSEC; certain embodiments may, additionally or alternatively, be applicable to other suitable protocols, including, for example, SoBGP, S-BGP, and PGPBGP, to name just a few.

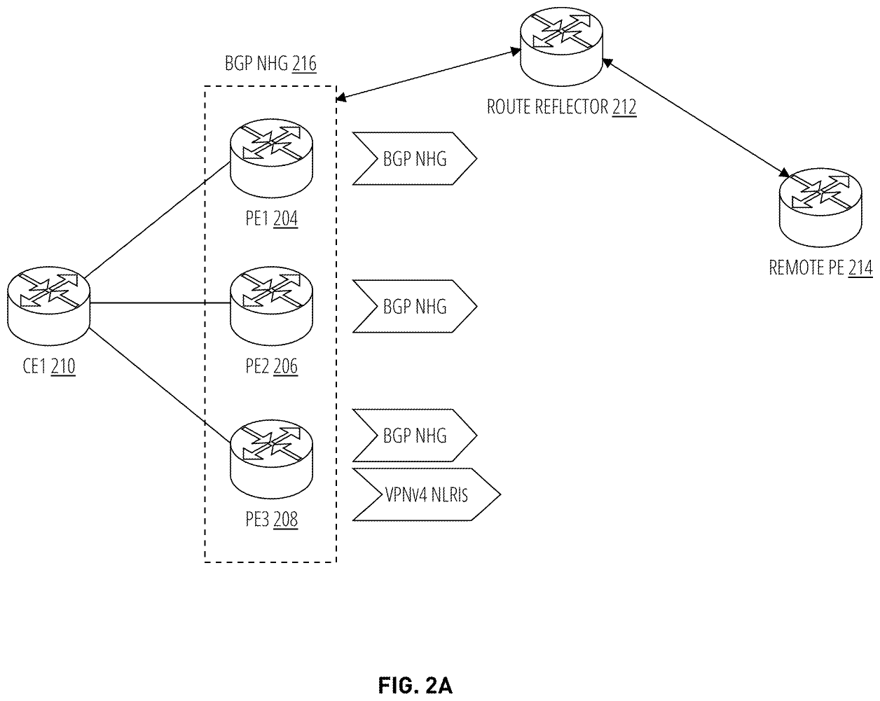

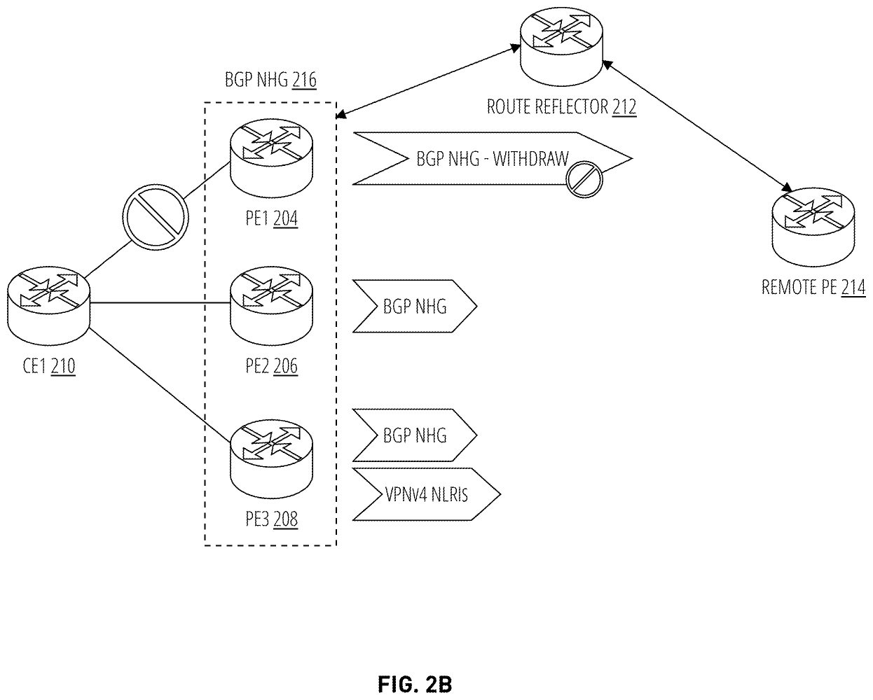

FIG. 2A illustrates an example block diagram of a border gateway protocol next-hop group (BGP-NHG) in accordance with aspects of the present disclosure. In addition to the border gateway protocol described in FIG. 1, a computer network may implement one or more next-hop groups to facilitate large-scale networking over the computer network. The border gateway protocol next-hop groups (BGP-NHG) may be a grouping for a set of paths on a router that can be shared by a number of destination prefixes. The BGP-NHG may comprise of one or more provider edge (PE) devices and a multi-homed client edge (CE) device. The one or more provider edge devices may be a group of redundant routers that are associated with a client device. The BGP-NHG may be identified by an identifier, such as an Internet Protocol (IP) address. The IP address may have local significance, and/or may have global significance (e.g., learned via signaling). The BGP-NHG may be instantiated statically by using a configuration without additional BGP signaling extensions (e.g., localized to a router). In some examples, the BGP-NHG may be instantiated dynamically by leveraging BGP signaling extensions (e.g., BGP-NHG service routes).

BGP-NHG 216 may be comprised of PE1 204, PE2 206, and PE3 208. BGP-NHG 216 may be associated with the multi-homed CE1 210. PE1 204, PE2 206, and PE3 208 connected to CE1 210 form a membership group BGP-NHG 216. BGP-NHG 216 may be associated with one address (e.g., an IP address, such as 10.10.10.1) that is associated with CE1 210. PE1 204, PE2 206, and PE3 208, members of BGP-NHG 216, may each originate a BGP-NHG route that announces, via membership signaling, to remote devices (e.g., remote PE 214) that the members are part of BGP-NHG 216 and ready to receive and forward traffic to CE1 210. Route reflector 212 may receive the signals from the members of BGP-NHG 216 and may transmit the signals to remote PE 214 and any other remote devices. In some examples, remote PE 214 may receive a request to connect to CE1 210. Using BGP-NHG 216, remote PE 214 may connect to CE1 210 using any member that is signaling as a part of BGP-NHG 216. In this example, remote PE 214 may connect to CE1 210 using PE1 204, PE2 206, or PE3 208. Redundant links, such as BGP-NHG 216 to CE1 210, can work in a load balancing mode or an active/standby mode to provide the desired reliability against network failures in a large scale network.

The membership signaling from each member device may be at least two types of signal, a “route withdraw” signal or a “route add” signal. The route add signal indicates that the PE device is ready to receive and forward traffic to the corresponding CE. The route withdraw signal indicates that the PE device is no longer connected to the corresponding CE and is no longer able to forward traffic to the corresponding CE. For example, if PE2 206 is connected to CE1 210, PE2 206 may transmit a route add membership signal, indicating to remote PE 214 and route reflector 212 that PE2 206 is available to receive traffic. The membership signaling may include an identifier (e.g., an IP address) associated with the BGP-NHG membership group (e.g., 10.10.10.1 associated with BGP-NHG 216). In some examples, the membership signaling may also include an indication of the specific PE device. Upon receipt of the membership signaling, a remote PE device (e.g., remote PE 214) and/or an associated route reflector (e.g., route reflector 212) may maintain a routing information base (RIB) and/or a forwarding information base (FIB) containing data corresponding to BGP-NHG 216 and associated PE devices (e.g., PE1 204, PE2 206, and PE3 208). The RIB and/or FIB table may be updated according to the PE devices and routes are available for traffic. For example, route reflector 212 may add PE1 204 to a RIB table upon receipt of a route add membership signal containing an indication of BGP-NHG 216 and an indication of PE1 204. Route reflector 212 and/or remote PE 214 may reference the RIB table when attempting to access CE1 210 to identify available service routes within BGP-NHG 216.

The membership group (e.g., BGP-NHG 216) may include a designated speaker. The designated speaker may be a PE device of the one or more PE devices belonging to the membership group. The elected speaker may signal the membership signal in addition to a prefix and VPN service route(s) (e.g., VPNv4 using Network Layer Reachability Information (NLRIs)) associated with the membership group. An IPV4 or IPv6 unicast NLRI may be used to signal the VPN service route(s). The prefix may be a tunnel encapsulation attribute included in the VPN service route(s). In some examples, the designated speaker may be the sole member device of the membership group signaling the prefix and VPN service route(s). The prefix may allow remote PE devices to immediately program a service route of the VPN service route(s) as reachable via the members of the membership group. For example, PE3 208 may be the designated speaker for BGP-NHG 216 and may signal route add in addition to a prefix associated with BGP-NHG 216 and one or more potential service routes. In some examples, route reflector 212 and/or remote PE 214 may store the prefix and/or the VPN service route(s) in the RIB table in association with BGP-NHG 216.

The designated speaker may be selected via election. In some examples, the designated speaker may be elected by an independent election amongst members of the associated membership group. This may require additional state exchanges between members of the membership group. In some examples, the designated speaker may be elected at an upstream node. The upstream node may collect one or more service routes associated with the membership group and/or PE device members of the membership group and elect a designated speaker based on the collected data. In some examples, the upstream node may utilize a deterministic algorithm to select a designated speaker (e.g., consistent hashing modulo-N, highest random weight, etc.). Once the designated speaker has been elected, the result may be signaled to the PE device members of the membership group. For example, PE3 208 may be elected as the designated speaker associated with BGP-NHG 216 and PE1 204, PE2 206, and PE3 208 may be signaled. In some examples, a secondary speaker may be elected in addition to the designated speaker. Upon failure of the designated speaker, the secondary speaker may become the designated speaker and a new secondary speaker may be elected.

FIG. 2B illustrates an example block diagram of a BGP-NHG with a failed customer-to-provider (CE-PE) connectivity failure in accordance with aspects of the present disclosure. BGP-NHG 216 may be comprised of one or more PE devices, which may include PE1 204, PE2 206, and PE3 208. BGP-NHG 216 may be associated with the multi-homed CE device CE1 210. Route reflector 212 may transmit one or more membership signals from PE1 204, PE2 206, and PE3 208 to a remote PE device (e.g., remote PE 214). PE3 208 may be the designated speaker associated with BGP-NHG 216. PE3 208 may signal a prefix associated with BGP-NHG 216 and/or one or more VPN service route(s) accessible by BGP-NHG 216.

PE2 206 may transmit a “route add” membership signal, indicating that PE2 206 is able to receive and transmit data to CE1 210. PE3 208 may transmit a route add membership signal in addition to the prefix associated with BGP-NHG 216 and/or the one or more VPN service route(s) accessible by BGP-NHG 216. In some examples, PE1 204 may lose connection to CE1 210 due to one or more reasons, including hardware failure, software failure, maintenance, updates, any combination thereof, or the like. The failure may cause PE1 204 to transmit a “route withdraw” membership signal, indicating that PE1 204 is unable to receive and transmit data to CE1 210. In a scaled network deployment of a large number of service routes learnt from a multi-homed CE (e.g., CE1 210), minimizing the control plane messaging and/or signaling in a BGP-NHG allows for faster control plane convergence. To optimize the amount of signaling in an instance of failed CE-PE connection, only one member device, alters signaling. In this example, PE1 204 is the only member device to alter signaling. In some examples, the designated speaker may incur a failed connection with CE1 210. In that instance, a secondary speaker may become the designated speaker (e.g., PE1 204 or PE2 206) and a new secondary speaker may be elected. For example, if PE3 208 fails, PE2 206 may be the secondary speaker and may then become the designated speaker, and PE1 204 may become the new secondary speaker.

After the output of the route withdraw signal from PE1 204, route reflector 212 and/or remote PE 214 may update a RIB table containing BGP-NHG 216. Membership data pertaining to BGP-NHG 216 may be updated according to the route withdraw membership signal received from PE1 204 (e.g., pruning PE1 204 from the RIB table). In some examples, PE1 204 may reconnect with CE1 210 and membership to BGP-NHG 216 would be re-established via a route add membership signal. In that instance, route reflector 212 and/or remote PE 214 may update the RIB table containing BGP-NHG 216 to include PE1 204.

In some examples, all member PE devices associated with BGP-NHG 216 may incur a failed CE-PE connection. As mentioned previously, when a single connection fails, the impacted PE device is removed from the BGP-NHG, but the VPN service route(s) remain reachable via the remaining PE devices. When the last CE-PE connection fails in BGP-NHG 216, BGP-NHG 216 is deleted at route reflector 212 and/or the remote PE 214. The designated speaker, in this case, PE3 208, may also send route withdraw, service route delete messages, etc.

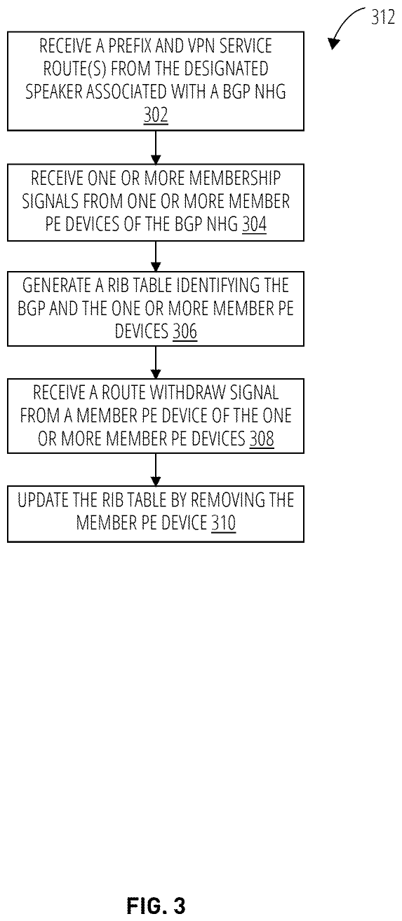

FIG. 3 illustrates an example flowchart for updating a routing information base (RIB) table following a CE-PE connectivity failure in accordance with aspects of the present disclosure. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes receiving a prefix and VPN service route(s) from the designated speaker associated with a BGP-NHG at block 302. In some examples, the designated speaker may be a PE device (e.g., PE3 208 as described in FIG. 2A) transmitting the prefix and VPN service route(s) associated with a BGP-NHG (e.g., BGP-NHG 216 as described in FIG. 2A) and being received by a route reflector (e.g., route reflector 212 as described in FIG. 2A) and/or a remote PE device (e.g., remote PE 214 as described in FIG. 2A). The BGP-NHG prefix allows remote PE devices to immediately program a service route advertised by a designated speaker as reachable via all members of the BGP-NHG, even if the remote PE device does not receive a service route from all the members of the BGP-NHG.

According to some examples, the method includes receiving one or more membership signals from one or more member PEs of the BGP-NHG at block 304. Members (e.g., PE1 204, PE2 206, and PE3 208 described in FIG. 2A) of the BGP-NHG may each transmit a membership signal. The membership signal may comprise a BGP-NHG service route that announces to remote PE devices that the respective signaling PE device is part of the BGP-NHG and ready to receive and forward traffic to a respective multi-homed CE device (e.g., a “route add” membership signal). In some examples, a membership signal may comprise a “route withdraw” signal that indicates that the signaling PE device has lost connectivity to the respective multi-homed CE device and that it can no longer receive traffic and forward it to the respective multi-homed CE device. The route reflector and/or the remote PE device may receive the one or more membership signals. Using the aforementioned method of signaling and messaging decreases the amount of signaling from the BGP-NHG in a large-scale deployment. By optimizing the amount of signaling, the amount of redundant signaling is reduced and there is no longer a heavy load on the control plane after an BGP-NHG event (e.g., a route add or a route withdraw). This increases the network convergence and results in better connectivity for a user of the network.

According to some examples, the method includes generating a RIB table identifying the BGP and the one or more member PE devices at block 306. In some examples, the route reflector and/or the remote PE device may generate the RIB table (or a path list) associated with the multi-homed CE device and/or the BGP-NHG. For example, the RIB table may include an indication of the multi-homed CE device (e.g., an IP address) and an indication of the associated BGP-NHG. In some other examples, the RIB table may include service routes for each member PE device of the BGP-NHG. The service routes may all be redundant routes capable of reaching a VPN service route associated with the BGP-NHG and/or the multi-homed CE device.

According to some examples, the method includes receiving a route withdraw signal from a member PE device of the one or more member PE devices at block 308. For example, a member PE device (e.g., PE1 204 as described in FIG. 3) may signal a route withdraw in the respective membership signal, indicating that the member PE device cannot receive traffic and forward it to the respective multi-homed CE device. All other associated signals (e.g., membership signals from other member PE device, signals from the designated speaker of the associated BGP-NHG, signals from the respective multi-homed CE device, etc.) may not change upon the route withdraw signal, reducing the load on the control plane and improving the control plane convergence after a CE-PE link failure (or in some instances, link restoration).

According to some examples, the method includes updating the RIB table by removing the member PE device at block 310. For example, the route reflector and/or the remote PE device may update the RIB table by removing the member PE device from the RIB table as a service route to access the multi-homed CE device via the BGP-NHG.

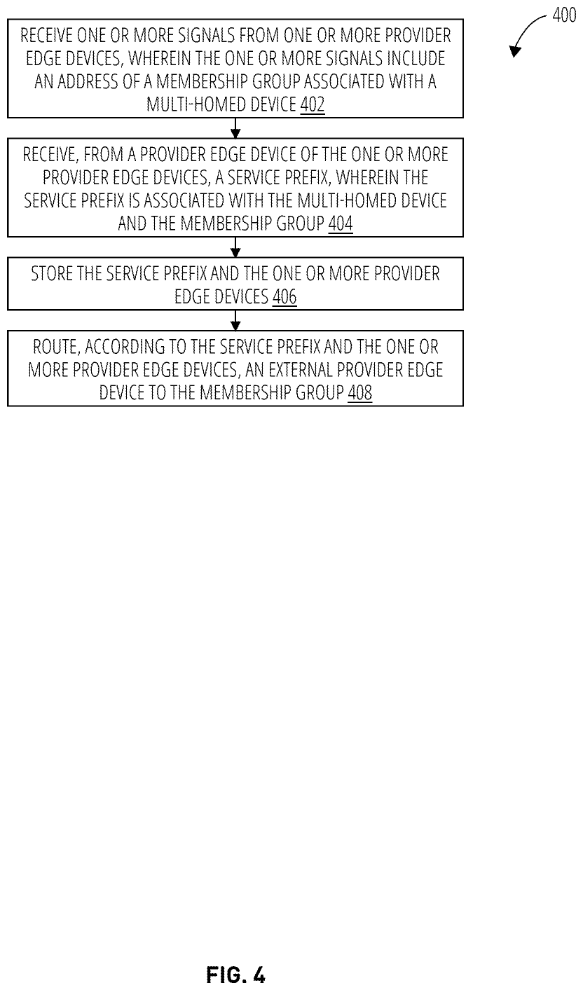

FIG. 4 illustrates an example flowchart for advertising service routes and signaling reachability in a BGP-NHG in accordance with aspects of the present disclosure. Although the example routine 400 depicts a particular sequence of operations, the sequence may be altered without departing from the scope of the present disclosure. For example, some of the operations depicted may be performed in parallel or in a different sequence that does not materially affect the function of the routine 400. In other examples, different components of an example device or system that implements the routine 400 may perform functions at substantially the same time or in a specific sequence.

According to some examples, the method includes receiving one or more signals from one or more provider edge devices, wherein the one or more signals include an address of a membership group associated with a multi-homed device at block 402. For example, a route reflector (e.g., route reflector 212 described in FIG. 2A) and/or a remote PE device (e.g., remote PE 214 described in FIG. 2A) may receive one or more signals, via a computer network (e.g., computer network 100 described in FIG. 1) from one or more provider edge devices (e.g., PE1 204, PE2 206, and/or PE3 208 described in FIG. 2A). The one or more signals may include an address of a BGP-NHG (e.g., BGP-NHG 216 described in FIG. 2A) associated with a multi-homed client device (e.g., CE1 210 described in FIG. 2A). The one or more signals may be membership signals. The membership signals may indicate the availability of a service route associated with a member PE device of the membership group.

According to some examples, the method includes receiving, from a provider edge device of the one or more provider edge devices, a service prefix, wherein the service prefix is associated with the multi-homed device and the membership group at block 404. For example, the provider edge device may be a designated speaker (e.g., PE3 208 described in FIG. 2B) and may signal the service prefix associated with a membership group (e.g., BGP-NHG 216 described in FIG. 2B). The designated speaker may be selected via election. In some examples, the designated speaker may be elected by an independent election amongst members of the associated membership group. This may required additional state exchanges between members of the membership group. In some examples, the designated speaker may be elected at an upstream node. The upstream node may collect one or more service routes associated with the membership group and/or PE device members of the membership group and elect a designated speaker based on the collected data. In some examples, the upstream node may utilize a deterministic algorithm to select a designated speaker (e.g., consistent hashing modulo-N, highest random weight, etc.). Once the designated speaker has been elected, the result may be signaled to the PE device members of the membership group.

The provider edge device may signal at least one of a membership signal, the service prefix, and VPN service route(s) associated with the membership group. An IPV4 or IPv6 unicast NLRI may be used to signal the VPN service route(s). The service prefix may be a tunnel encapsulation attribute included in the VPN service route(s). The service prefix may allow remote PE devices to immediately program a service route of the VPN service route(s) as reachable via the members of the membership group.

According to some examples, the method includes storing the service prefix and the one or more provider edge devices at block 406. For example, the route reflector and/or the remote PE device may store the service prefix in a RIB table in association with the multi-homed client device and/or the membership group. For example, the RIB table may include an indication of the multi-homed client device (e.g., an IP address) and an indication of the membership group. In some other examples, the RIB table may include service routes for each member PE device of the membership group. The service routes may all be redundant routes capable of reaching a VPN service route associated with the membership group and/or the multi-homed client device.

According to some examples, the method includes connecting, according to the service prefix and the one or more provider edge devices, to the multi-homed device associated with the membership group at block 408. For example, the remote PE device (e.g., remote PE 214 described in FIG. 2A) may connect to a member PE device of the membership group based on the data stored in the RIB table. In some examples, the route reflector (e.g., route reflector 212 described in FIG. 2A) may direct traffic from the remote PE device to a member PE device of the membership group based on the data stored in the RIB table.

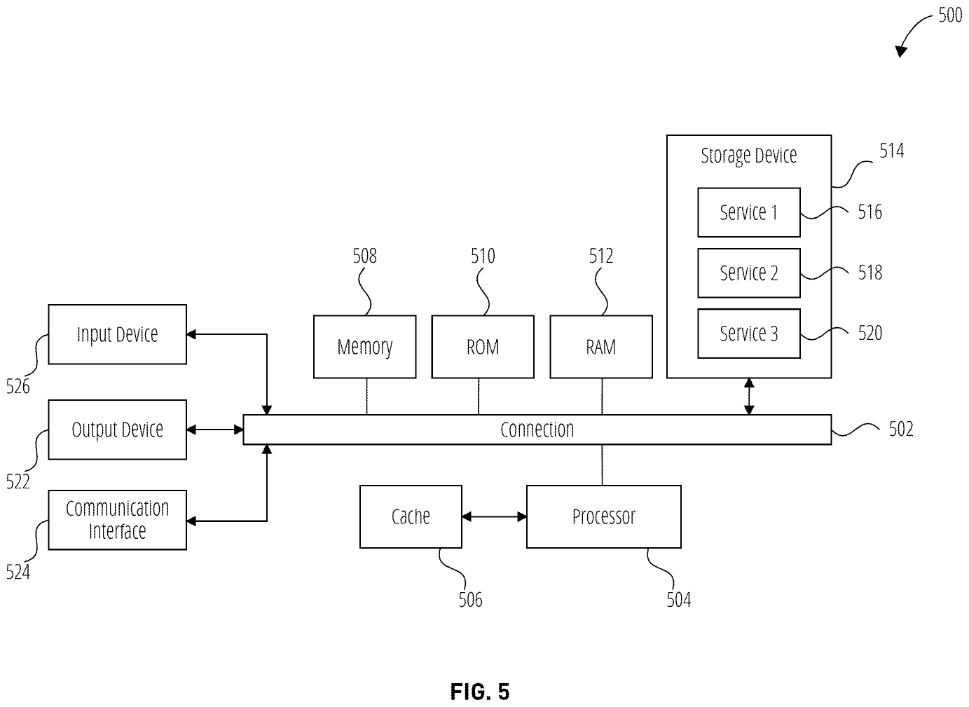

FIG. 5 shows an example of computing system 500, which can be for example any computing device making up one or more of the components described in FIGS. 1-4, or any component thereof in which the components of the system are in communication with each other using connection 502. Connection 502 can be a physical connection via a bus, or a direct connection into processor 504, such as in a chipset architecture. Connection 502 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 500 includes at least one processing unit (CPU or processor) 504 and connection 502 that couples various system components including system memory 508, such as read-only memory (ROM) 510 and random access memory (RAM) 512 to processor 504. Computing system 500 can include a cache of high-speed memory 506 connected directly with, in close proximity to, or integrated as part of processor 504.

Processor 504 can include any general purpose processor and a hardware service or software service, such as services 516, 518, and 520 stored in storage device 514, configured to control processor 504 as well as a special-purpose processor where software instructions are incorporated into the actual processor design. Processor 504 may essentially be a completely self-contained computing system, containing multiple cores or processors, a bus, memory controller, cache, etc. A multi-core processor may be symmetric or asymmetric.

To enable user interaction, computing system 500 includes an input device 526, which can represent any number of input mechanisms, such as a microphone for speech, a touch-sensitive screen for gesture or graphical input, keyboard, mouse, motion input, speech, etc. Computing system 500 can also include output device 522, which can be one or more of a number of output mechanisms known to those of skill in the art. In some instances, multimodal systems can enable a user to provide multiple types of input/output to communicate with computing system 500. Computing system 500 can include communication interface 524, which can generally govern and manage the user input and system output. There is no restriction on operating on any particular hardware arrangement, and therefore the basic features here may easily be substituted for improved hardware or firmware arrangements as they are developed.

Storage device 514 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 514 can include software services, servers, services, etc., that when the code that defines such software is executed by the processor 504, it causes the system to perform a function. In some embodiments, a hardware service that performs a particular function can include the software component stored in a computer-readable medium in connection with the necessary hardware components, such as processor 504, connection 502, output device 522, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method of reducing border gateway protocol (BGP) signaling for multi-homed devices, comprising:
receiving one or more signals from one or more provider edge devices, wherein the one or more signals include an address of a membership group associated with a multi-homed device;
receiving, from a provider edge device of the one or more provider edge devices, a service prefix, wherein the service prefix is associated with the multi-homed device and the membership group;
storing the service prefix and the one or more provider edge devices; and
connecting, according to the service prefix and the one or more provider edge devices, to the multi-homed device associated with the membership group.

2. The computer-implemented method of claim 1, further comprising:
updating the stored service prefix and the stored one or more provider edge devices after a deviation of the one or more signals.

3. The computer-implemented method of claim 2, wherein the deviation is caused by a change of a signal of the one or more signals, indicating a withdrawal of a failed provider edge device from the membership group.

4. The computer-implemented method of claim 2, wherein the deviation is caused by a change of a signal of the one or more signals, indicating an addition of a new provider edge device to the membership group.

5. The computer-implemented method of claim 1, wherein the provider edge device is an elected provider edge device selected by the one or more provider edge devices of the membership group.

6. The computer-implemented method of claim 1, wherein the service prefix is further associated with one or more VPN service routes.

7. The computer-implemented method of claim 6, wherein the one or more VPN service routes are updated according to a withdrawal of a failed provider edge device by removing a VPN service route of the one or more VPN service routes, wherein the VPN service route is associated with the failed provider edge device.

8. The computer-implemented method of claim 1, wherein the service prefix and the one or more provider edge devices are stored in a data table associated with the membership group.

9. A computing apparatus comprising:
a processor; and
a memory storing instructions that, when executed by the processor, configure the apparatus to:
receive one or more signals from one or more provider edge devices, wherein the one or more signals include an address of a membership group associated with a multi-homed device;
receive, from a provider edge device of the one or more provider edge devices, a service prefix, wherein the service prefix is associated with the multi-homed device and the membership group;
store the service prefix and the one or more provider edge devices; and
connect, according to the service prefix and the one or more provider edge devices, to the multi-homed device associated with the membership group.

10. The computing apparatus of claim 9, wherein the instructions further configure the apparatus to:
update the stored service prefix and the stored one or more provider edge devices after a deviation of the one or more signals.

11. The computing apparatus of claim 10, wherein the deviation is caused by a change of a signal of the one or more signals, indicate a withdrawal of a failed provider edge device from the membership group.

12. The computing apparatus of claim 10, wherein the deviation is caused by a change of a signal of the one or more signals, indicate an addition of a new provider edge device to the membership group.

13. The computing apparatus of claim 9, wherein the provider edge device is an elected provider edge device selected by the one or more provider edge devices of the membership group.

14. The computing apparatus of claim 9, wherein the service prefix is further associated with one or more VPN service routes.

15. The computing apparatus of claim 14, wherein the one or more VPN service routes are updated according to a withdrawal of a failed provider edge device by removing a VPN service route of the one or more VPN service routes, wherein the VPN service route is associated with the failed provider edge device.

16. The computing apparatus of claim 9, wherein the service prefix and the one or more provider edge devices are stored in a data table associated with the membership group.

17. A non-transitory computer-readable storage medium, the non-transitory computer-readable storage medium including instructions that when executed by a computer, cause the computer to:
receive one or more signals from one or more provider edge devices, wherein the one or more signals include an address of a membership group associated with a multi-homed device;
receive, from a provider edge device of the one or more provider edge devices, a service prefix, wherein the service prefix is associated with the multi-homed device and the membership group;
store the service prefix and the one or more provider edge devices; and
connect, according to the service prefix and the one or more provider edge devices, to the multi-homed device associated with the membership group.

18. The non-transitory computer-readable storage medium of claim 17, wherein the instructions further cause the computer to:
update the stored service prefix and the stored one or more provider edge devices after a deviation of the one or more signals.

19. The non-transitory computer-readable storage medium of claim 18, wherein the deviation is caused by a change of a signal of the one or more signals, indicate a withdrawal of a failed provider edge device from the membership group.

20. The non-transitory computer-readable storage medium of claim 18, wherein the deviation is caused by a change of a signal of the one or more signals, indicate an addition of a new provider edge device to the membership group.
